(19) United States
(12) Patent Application Publication
(10) Pub. No.: US 2013/0069977 A1
(43) Pub. Date: Mar. 21, 2013

(54) IMAGE DISPLAY METHOD, SERVER AND IMAGE DISPLAY SYSTEM

(71) Applicant: Masami Yuyama, Tokyo (JP)

(72) Inventor: Masami Yuyama, Tokyo (JP)

(73) Assignee: CASIO COMPUTER CO., LTD., Tokyo (JP)

(21) Appl. No.: 13/608,291

(22) Filed: Sep. 10, 2012

(30) Foreign Application Priority Data
Sep. 21, 2011 (JP) 2011-205578

(51) Int. Cl. G09G 5/00

(52) U.S. Cl. 345/619

(57) ABSTRACT

An image display method using a display apparatus that displays an image, and using a server communicably connected to the display apparatus through a network, includes: obtaining a post-processing-unneeded image of a format displayable without performing post-processing by the display apparatus based on display-related information related to an image display performance of the display apparatus, the obtaining being performed by the server; transmitting the post-processing-unneeded image obtained in the obtaining to the display apparatus, the transmitting being performed by the server; receiving the post-processing-unneeded image transmitted from the server, the receiving being performed by the display apparatus; and displaying the post-processing-unneeded image received by the receiving, the displaying being performed by the display apparatus.

### CROSS-REFERENCE TO RELATED APPLICATIONS

This application is based upon and claims the benefit of priority from the prior Japanese Patent Application No. 2011-205578, filed on Sep. 21, 2011, the entire contents of which are incorporated herein by reference.

### BACKGROUND OF THE INVENTION

1. Field of the Invention

The present invention relates to an image display method, a server and an image display system.

2. Description of Related Art

Heretofore, there has been a display apparatus such as a digital photo frame that displays an image stored therein in advance (Japanese Patent Laid-Open Publication No. 2011-129033).

However, for example, in order to display an image that has a higher resolution than a screen resolution of the display apparatus concerned, an image that does not correspond to an image format displayable by the display apparatus concerned, or the like, the conventional display apparatus has had to perform predetermined post-processing so that the image concerned can be displayable by the display apparatus.

### SUMMARY OF THE INVENTION

It is an object of the present invention to provide an image display method, a server and an image display system, which enable the display apparatus to display the image without performing the post-processing.

According to an aspect of the present invention, there is provided an image display method using a display apparatus that displays an image, and using a server communicably connected to the display apparatus through a network, the image display method including:

obtaining a post-processing-unneeded image of a format displayable without performing post-processing by the display apparatus based on display-related information related to an image display performance of the display apparatus, the obtaining being performed by the server;

transmitting the post-processing-unneeded image obtained in the obtaining to the display apparatus, the transmitting being performed by the server;

receiving the post-processing-unneeded image transmitted from the server, the receiving being performed by the display apparatus; and

displaying the post-processing-unneeded image received by the receiving, the displaying being performed by the display apparatus.

According to another aspect of the present invention, there is provided a server communicably connected to a display apparatus that displays an image through a network, the server including:

an obtaining unit which obtains a post-processing-unneeded image of a format displayable without performing post-processing by the display apparatus based on display-related information related to an image display performance of the display apparatus; and

an image transmission unit which transmits the post-processing-unneeded image obtained by the obtaining unit to the display apparatus.

According to still another aspect of the present invention, there is provided an image display system including a display apparatus that displays an image, and a server communicably connected to the display apparatus through a network,

and the server includes:

an obtaining unit which obtains a post-processing-unneeded image of a format displayable without performing post-processing by the display apparatus based on display-related information related to an image display performance of the display apparatus; and

an image transmission unit which transmits the post-processing-unneeded image obtained by the obtaining unit to the display apparatus;

and the display apparatus includes:

an image reception unit which receives the post-processing-unneeded image transmitted from the server; and

a display unit which displays the post-processing-unneeded image received by the image reception unit.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a block diagram showing a main configuration of an image display system 1 according to an embodiment of the present invention;

FIG. 2 is a flowchart showing an example of a flow of image display processing by the image display system 1;

FIG. 3 is a flowchart showing an example of a flow of image creation processing;

FIG. 4 is a flowchart showing an example of a flow of color temperature adjustment processing;

FIG. 5 is a flowchart showing an example of a flow of brightness adjustment processing;

FIG. 6A is a view showing an example of data stored in a storage unit;

FIG. 6B is a view showing an example of the data stored in the storage unit;

FIG. 6C is a view showing an example of the data stored in the storage unit;

FIG. 6D is a view showing an example of the data stored in the storage unit;

FIG. 7 is a view showing an example of a flow of image data related to obtainment of post-processing-unneeded images.

FIG. 8A is a view showing an example of image processing to be implemented by a server;

FIG. 8B is a view showing an example of the image processing to be implemented by the server;

FIG. 8C is a view showing an example of the image processing to be implemented by the server;

FIG. 9A is a view showing an example of a case where display-related information and environment-related information are transmitted from a display apparatus to the server;

FIG. 9B is a view showing an example of a case where the post-processing-unneeded image is transmitted from the server to the display apparatus; and

FIG. 9C is a view showing an example of a case where the post-processing-unneeded image is displayed by the display apparatus.

### DETAILED DESCRIPTION OF THE PREFERRED EMBODIMENT

A description is made below of a specific aspect of the present invention by using the drawings. However, the scope of the invention is not limited to the illustrated example.

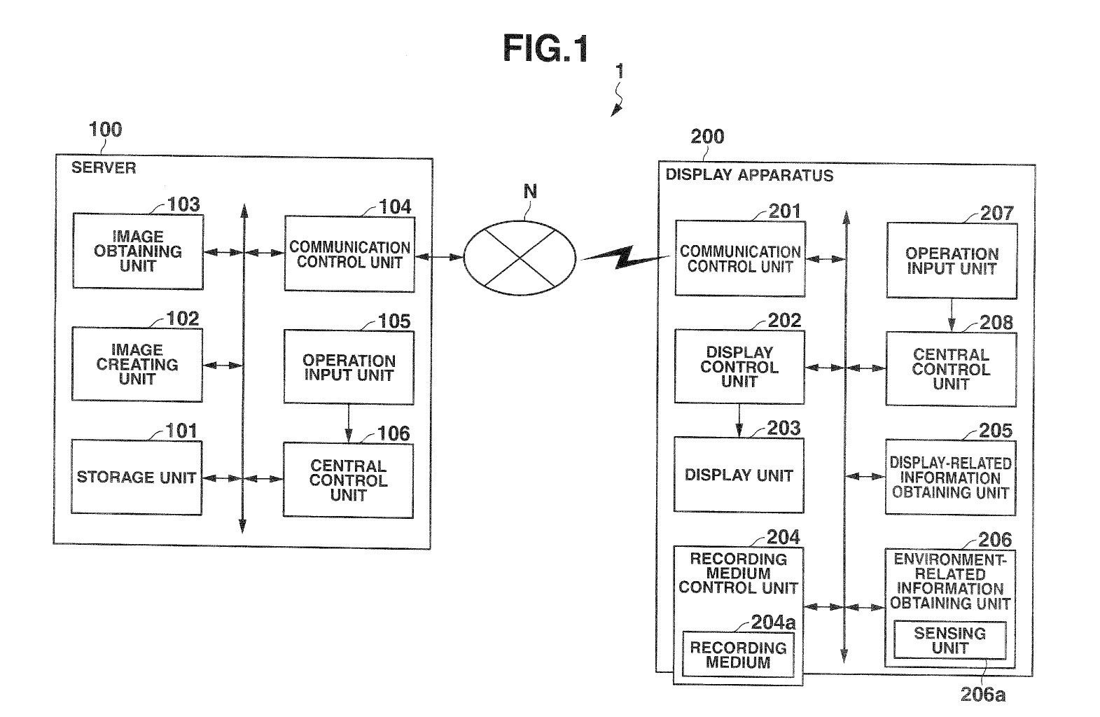

FIG. 1 is a block diagram showing a main configuration of an image display system 1 according to an embodiment of the present invention.

An image display system 1 is an image display system including a server 100 and a display apparatus 200. The server 100 and the display apparatus 200 are communicably connected to each other through a communication network N.

Note that, for example, the communication network N is a communication network constructed by using a dedicated line or an existing general public line, and it is possible to apply a variety of line forms such as a local area network (LAN) and a wide area network (WAN). Moreover, for example, the communication network N includes: a variety of communication networks such as a telephone network, an ISDN network, a dedicated line, a mobile network, a communication satellite line, and a CATV network; an internet service provider that connects these to one another; and the like.

Moreover, though the single server 100 and the single display apparatus 200 are communicably connected to each other in the example shown in FIG. 1, a plurality of the display apparatuses 200 may be connected to the single server 100.

Based on display-related information related to image display performance of the display apparatus 200, and the like, the server 100 obtains post-processing-unneeded images of a format displayable without being subjected to predetermined post-processing by the display apparatus concerned, and transmits the obtained post-processing-unneeded images to the display apparatus 200.

The server 100 includes: a storage unit 101; an image creating unit 102; an image obtaining unit 103; a communication control unit 104; an operation input unit 105; and a central control unit 106.

The storage unit 101 stores a variety of data to be handled by the server 100.

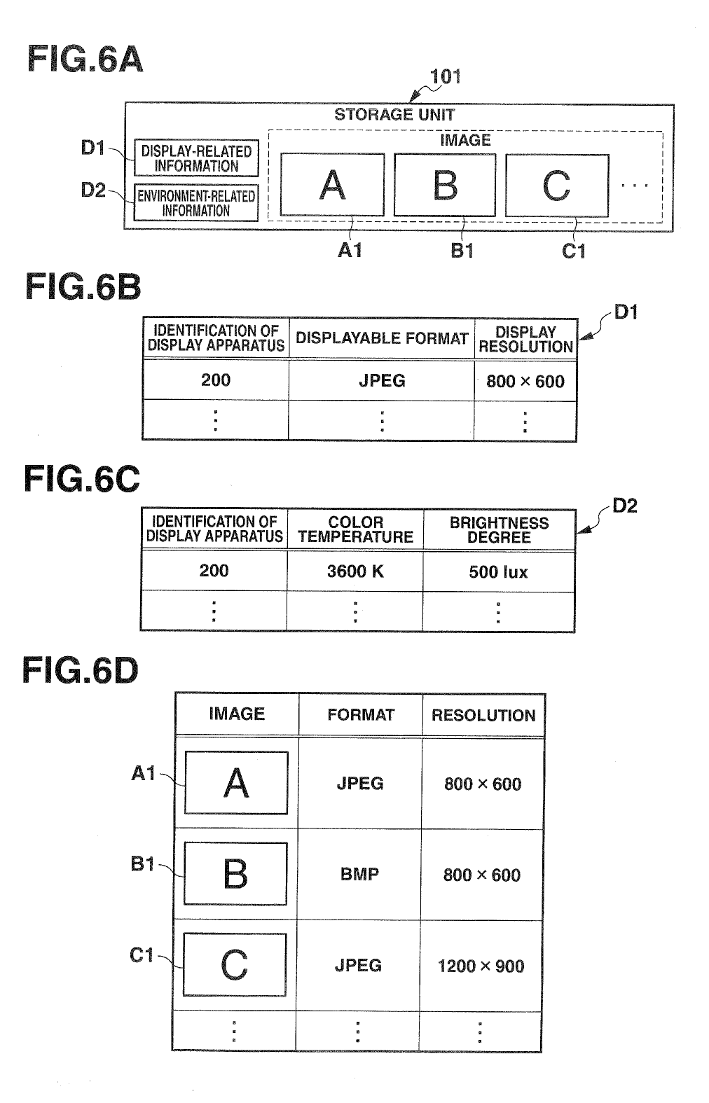

For example, the storage unit 101 has a storage device such as a hard disk drive (HDD) and a solid state drive (SSD). For example, as shown in FIG. 6A, the storage unit 101 stores a variety of data such as the display-related information, environment-related information, and a plurality of images.

The display-related information is information related to the image display performance of the display apparatus 200. As the information related to such display performance, for example, there are mentioned: an image format (a displayable format) displayable by the display apparatus 200; a resolution (a display resolution) of a display unit 203 of the display apparatus 200; and the like. In the display-related information, information for identifying the display apparatus 200 and a variety of specific information (for example, the displayable format, the display resolution, and the like) included in the display-related information of the display apparatus 200 are associated with each other.

In the display-related information according to an example shown in FIG. 6B, “200” as the information for identifying the display apparatus 200, “JPEG” indicating the displayable format and “800×600” indicating the display resolution are associated with one another. The display-related information shown in FIG. 6B shows that the display apparatus 200 is capable of displaying an image of the JPEG format, and that the display unit 203 has a resolution with 800 [pixels] in a predetermined direction (for example, a longitudinal direction) and with 600 [pixels] in other direction (for example, a lateral direction) perpendicular to the predetermined direction concerned.

Note that the storage unit 101 may store respective pieces of the display-related information of the plurality of display apparatuses. The storage unit 101 may store the respective pieces of display-related information of the plurality of display apparatuses collectively in one file, or may store the respective pieces of display-related information of the plurality of display apparatuses as individual files.

The environment-related information is information related to an environment of a place where the display apparatus exists. As the information related to the environment, for example, there are mentioned: a color temperature of light that illuminates a space where the display apparatus 200 exists; a degree of brightness by the light; and the like. In the environment-related information, the information for identifying the display apparatus 200 and a variety of specific information (for example, the color temperature, such a brightness degree, and the like) included in the environment-related information of the display apparatus 200 are associated with each other.

In the environment-related information according to an example shown in FIG. 6C, “200” as the information for identifying the display apparatus 200, “3600 Kelvin ([K])” indicating the color temperature and “500 [lux] ” are associated with one another. The environment-related information shown in FIG. 6C shows that the color temperature of the light that illuminates the space where the display apparatus 200 exists is 3600 [K], and that the degree of the brightness by the light is 500 [lux].

Note that the storage unit 101 may store respective pieces of the environment-related information of the plurality of display apparatuses. The storage unit 101 may store the respective pieces of environment-related information of the plurality of display apparatuses collectively in one file, or may store the respective pieces of environment-related information of the plurality of display apparatuses as individual files.

For example, as shown in FIG. 6D, the storage unit 101 can store a plurality of images having different formats and resolutions from one another. In the example of FIG. 6A, the storage unit 101 stores a plurality of images such as an image A1, an image B1 and an image C1. Moreover, as shown in FIG. 6D, a format of the image A1 is JPEG, and a resolution thereof is 800×600. Moreover, a format of the image B1 is bitmap (BMP), and a resolution thereof is 800×600. Furthermore, a format of the image C1 is JPEG, and a resolution thereof is 1200×900.

The image creating unit 102 implements predetermined processing for the images stored in the storage unit 101.

Specifically, the image creating unit 102 performs a variety of image processing for converting the images stored in the storage unit 101 into the post-processing-unneeded images, for example, based on the display-related information and the environment-related information.

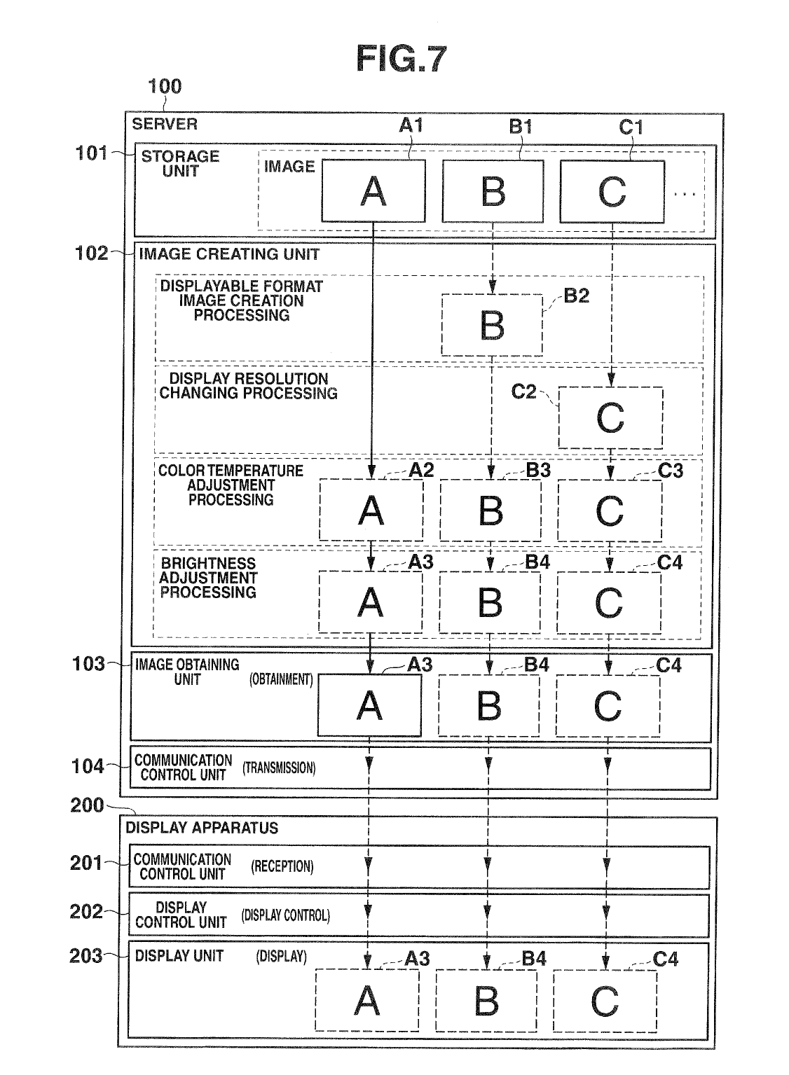

Among the variety of image processing, as processing that is based on the display-related information, for example, as shown in FIG. 7, displayable format image creation processing, display resolution changing processing and the like are mentioned. The displayable format image creation processing is processing for creating the displayable format from an image of a format that is not displayable by the display apparatus 200. The display resolution changing processing is processing for lowering a resolution of an image that has a higher resolution than the display resolution of the display apparatus 200 and changing the resolution of the image concerned to a resolution suitable for the display by the display apparatus 200.

Moreover, among the variety of image processing, as processing that is based on the environment-related information, color temperature adjustment processing, brightness adjustment processing and the like are mentioned. The color temperature adjustment processing is processing for adjusting values of color-difference signals in response to the color temperature of the light that illuminates the space where the display apparatus 200 exists. The brightness adjustment processing is processing for adjusting tone curves of the images in response to the degree of the brightness by the light that illuminates the space where the display apparatus 200 exists.

The processing that is based on the environment-related information, such as the color temperature adjustment processing and the brightness adjustment processing, is processing for allowing the image obtaining unit 103 to obtain the post-processing-unneeded images of the format displayable while leaving predetermined image quality adjustment processing undone. The post-processing-unneeded images of the format displayable while leaving the predetermined image quality adjustment processing undone are images in which no change occurs in visual recognition in the space where the display apparatus 200 exists even if a change occurs in such an environment related to the visual recognition concerned.

For example, as the environment related to the visual recognition of the image in the space where the display apparatus 200 exists, there are the color temperature and brightness degree of the light that illuminates the space where the display apparatus 200 exists, and the like. It is possible that the color temperature and brightness degree of the light concerned may be changed by a variety of causes such as changes including whether or not there is a sun beam and how intense the sun beam is, the changes following a change of a time in a day, and whether or not illumination is turned on. The post-processing-unneeded images of the format displayable while leaving the predetermined image quality adjustment processing undone are images in which no change occurs in visual recognition with regard to color expression and contrast of the image without performing the image processing by the display apparatus 200, for example, even in the case where a change of the environment occurs owing to such changes of the color temperature and brightness degree of the light as described above.

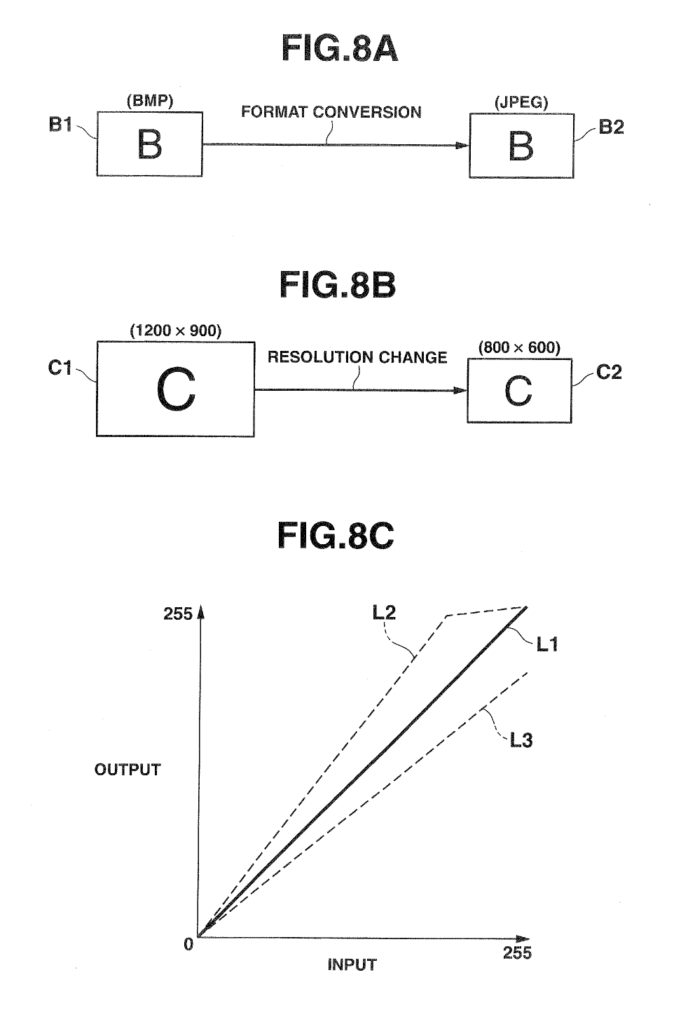

A description is made below of the variety of image processing with reference to FIG. 8A to FIG. 8C.

For example, the image B1 is an image of the BMP format, and is an image in which a format is not the format (the JPEG format) displayable by the display apparatus 200. For example, as shown in FIG. 8A, the image creating unit 102 performs displayable format image creation processing for creating an image B2 of the JPEG format as the format displayable by the display apparatus 200 from the image B1 of the BMP format.

Moreover, an image C1 is an image having a resolution of 1200×900, and is an image having a higher resolution than 800×600 as the display resolution of the display apparatus 200. For example, as shown in FIG. 8B, the image creating unit 102 performs display resolution changing processing for creating an image C2 having a resolution of 800×600, which corresponds to the display resolution of the display apparatus 200, from the image C1 having the resolution of 1200×900.

Note that the image C1 is an image in which numbers of pixels in both of predetermined two directions (for example, the longitudinal direction and the lateral direction) are larger than the numbers of pixels in two directions, which are indicated by the display resolution; however, the image C1 is merely an example of “the image having the higher resolution than the display resolution”, and “the image having the higher resolution than the display resolution” is not limited to the image C1. For example, an image in which the number of pixels in either of the predetermined two directions, which is indicated by the display resolution, is larger than the number of pixels, which is indicated by the display resolution, may be “the image having the higher resolution than the display resolution”. In this case, the image creating unit 102 performs reduction processing for reducing the number of pixels in the direction having a larger number of pixels than the number of pixels, which is indicated by the display resolution, to the number of pixels in the direction concerned, which is indicated by the display resolution, or less. Here, the image creating unit 102 may perform the reduction processing so as not to change a ratio of the two directions of the image.

Moreover, though not shown, in the case where the image in which the format is not displayable has the higher resolution than the display resolution, the image creating unit 102 implements both of the displayable format image creation processing and the display resolution changing processing for the image concerned in order to create the post-processing-unneeded image. In this case, for example, the image creating unit 102 first implements the displayable format image creation processing, thereby creates the image of the displayable format, and implements the resolution change that allows the resolution of the created image to correspond to the display resolution. A processing order of the displayable format image creation processing and the display resolution changing processing may be inverse.

Moreover, for example, in the case where a value of the color temperature included in the environment-related information exceeds a first threshold value (for example, 7000 [K]), the image creating unit 102 performs color temperature adjustment processing for relatively emphasizing a red color of the image in comparison with that before being subjected to such adjustment and relatively weakening a blue color of the image in comparison with that before being subjected to the adjustment.

For example, in the case where a value of the color temperature of the light that illuminates the space where the display apparatus 200 exits exceeds 7000 [K], a color of the image displayed by the display apparatus 200 becomes bluish by the light concerned. Under the light concerned, expression of the blue color included in the image tends to be particularly emphasized, and meanwhile, expression of the red color included therein tends to become inconspicuous. Accordingly, for the image, the image creating unit 102 implements the color temperature adjustment processing for relatively emphasizing the red color of the image and relatively weakening the blue color of the image, thereby cancelling the emphasis of the blue color, which is caused by the light in which the value of the color temperature exceeds 7000 [K], and the like. In such a way, more natural color expression can be achieved for the image displayed by the display apparatus 200 in the space illuminated by the light concerned, and a user can be allowed to visually recognize such an image with natural color expression without being affected by the value of the color temperature of the light that illuminates the space where the display apparatus 200 exists.

Moreover, for example, in the case where the value of the color temperature included in the environment-related information falls down below a second threshold value (for example, 3500 [K]), the image creating unit 102 performs color temperature adjustment processing for relatively emphasizing the blue color of the image in comparison with that before being subjected to such adjustment and relatively weakening the red color of the image in comparison with that before being subjected to the adjustment.

For example, in the case where the value of the color temperature of the light that illuminates the space where the display apparatus 200 exists falls down below 3500 [K], the color of the image displayed by the display apparatus 200 becomes reddish. Under the light concerned, the expression of the red color included in the image tends to be particularly emphasized, and meanwhile, the expression of the blue color included therein tends to become inconspicuous. Accordingly, for the image, the image creating unit 102 implements the color temperature adjustment processing for relatively emphasizing the blue color of the image and relatively weakening the red color of the image, thereby cancelling the emphasis of the red color, which is caused by the light in which the value of the color temperature falls down below 3500 [K], and the like. In such a way, more natural color expression can be achieved for the image displayed by the display apparatus 200 in the space illuminated by the light concerned, and the user can be allowed to visually recognize such an image with natural color expression without being affected by the value of the color temperature of the light that illuminates the space where the display apparatus 200 exists.

In the event of performing the color temperature adjustment processing, specifically, the image creating unit 102 first obtains color-difference signals (Cb, Cr) from the images (for example, the image A1, the image B2, the image C2 and the like, which are shown in FIG. 7) before being subjected to the color temperature adjustment processing. Then, the image creating unit 102 adjusts values of the color-difference signals in response to the value of the color temperature included in the environment-related information. In FIG. 7, images after being subjected to the color temperature adjustment processing are defined as an image A2, an image B3 and an image C3.

For example, in the case where the value of the color temperature of the light exceeds 7000 [K], the image creating unit 102 divides the value of the color-difference signal Cb by a predetermined value (for example, 1.2), and multiplies the value of the color-difference signal Cr by the predetermined value, thereby implementing, for each of the images, the color temperature adjustment processing for relatively emphasizing the red color of the image and relatively weakening the blue color of the image. Moreover, in the case where the value of the color temperature of the light falls down below 3500 [K], the image creating unit 102 multiplies the value of the color-difference signal Cb by a predetermined value (for example, 1.2), and divides the value of the color-difference signal Cr by the predetermined value, thereby implementing the color temperature adjustment processing for relatively emphasizing the blue color of the image and relatively weakening the red color of the image for the image.

Moreover, for example, in the case where the value of the brightness degree included in the environment-related information exceeds a third threshold value (for example, 1000 [lux]), the image creating unit 102 performs brightness adjustment processing for increasing the brightness of each of the images in comparison with that before being subjected to the adjustment.

For example, in the case where the brightness degree of the light that illuminates the space where the display apparatus 200 exists exceeds 1000 [lux], an apparent gradation of the image displayed under an environment illuminated by the light concerned tends to be lowered. In particular, in the case where an image with low brightness is displayed under the environment illuminated by the light concerned, the lowering of the gradation is visually recognized to a significant extent. Accordingly, the image creating unit 102 adjusts the tone curve of the image, and converts the image before being subjected to such adjustment into an image with more brightness than that of the image concerned, thereby can impart natural gradation expression to the image to be displayed by the display apparatus 200 in the space illuminated by the light concerned, and can allow the user to visually recognize such an image with natural gradation expression without being affected by the value of the color temperature of the light that illuminates the space where the display apparatus 200 exits.

Moreover, for example, in the case where the value of the brightness degree included in the environment-related information exceeds a fourth threshold value (for example, 100 [lux]), the image creating unit 102 performs brightness adjustment processing for lowering the brightness of each of the images in comparison with that before being subjected to the adjustment.

For example, in the case where the value of the brightness by the light that illuminates the space where the display apparatus 200 exists falls down below 100 [lux], the apparent gradation of the image displayed under the environment illuminated by the light concerned tends to be increased. In particular, in the case where an image with high brightness is displayed under the environment illuminated by the light concerned, a whiteout condition and the like occur, and it becomes difficult to visually recognize a gradation change of a bright portion of the image. Accordingly, the image creating unit 102 adjusts the tone curve of the image, and converts the image before being subjected to such adjustment into an image with more darkness than that of the image concerned, thereby can impart natural gradation expression to the image to be displayed by the display apparatus 200 in the space illuminated by the light concerned, and can allow the user to visually recognize such an image with natural gradation expression without being affected by the value of the color temperature of the light that illuminates the space where the display apparatus 200 exits.

In the event of performing the brightness adjustment processing, specifically, the image creating unit 102 first obtains the tone curves of the images (for example, the image A2, the image B3, the image C3 and the like, which are shown in FIG. 7) before being subjected to the brightness adjustment processing. Then, the image creating unit 102 adjusts the tone curves in response to the value of the brightness degree included in the environment-related information. In FIG. 7, images after being subjected to the color temperature adjustment processing are defined as an image A3, an image B4 and an image C4.

For example, in the case where the value of the brightness degree exceeds 1000 [lux], then as shown in FIG. 8C, the image creating unit 102 applies a tone curve L2, in which the brightness of the image is increased in comparison with a tone curve L1 before the brightness adjustment processing, to the image concerned.

Moreover, in the case where the value of the brightness degree falls down below 100 [lux], the image creating unit 102 applies a tone curve L3, in which the brightness of the image is lowered in comparison with the tone curve L1 before the brightness adjustment processing, to the image concerned.

The image obtaining unit 103 functions as an obtaining unit that obtains the post-processing-unneeded images.

Specifically, for example, as shown FIG. 7, the image obtaining unit 103 obtains the post-processing-unneeded images (for example, the image A3, the image B4, the image C4 and the like, which are shown in FIG. 7) created by the image creating unit 102.

Moreover, in the case where it is determined that the images stored in the storage unit 101 are the post-processing-unneeded images corresponding to the display-related information and the environment-related information, the image obtaining unit 103 may obtain the images, which are determined to be the post-processing-unneeded images, from the storage unit 101.

For example, the image A1 is an image of the JPEG format, and is an image having a resolution of 800×600. Here, in the case where the displayable format and the display resolution, which are included in the display-related information, are the JPEG format and 800×600, respectively as in the display-related information shown in FIG. 6B, it is not necessary to implement the displayable format image creation processing and the color temperature adjustment processing for the image A1. Moreover, in the case where the color temperature and the brightness degree, which are included in the environment-related information, are 3600 [K] and 500 [lux], respectively as in the environment-related information shown in FIG. 6C, it is not necessary to implement the color temperature adjustment processing and the brightness adjustment processing since these color temperature and brightness degree have intermediate values between a variety of the threshold values serving as conditions for implementing the color temperature adjustment processing and the brightness adjustment processing. In the case of such an example, the image obtaining unit 103 may obtain the image A1 as the post-processing-unneeded image from the storage unit 101.

Moreover, the image obtaining unit 103 may obtain a plurality of the post-processing-unneeded images. In this case, for each of the images stored in the storage unit 101, the image obtaining unit 103 may obtain the post-processing-unneeded image, which is created by being subjected to the image processing by the image creating unit 102, individually according to needs. Alternatively, in the case where a plurality of the post-processing-unneeded images corresponding to the display-related information and the environment-related information are stored in the storage unit 101, the image obtaining unit 103 may obtain the plurality of post-processing-unneeded images stored in the storage unit 101.

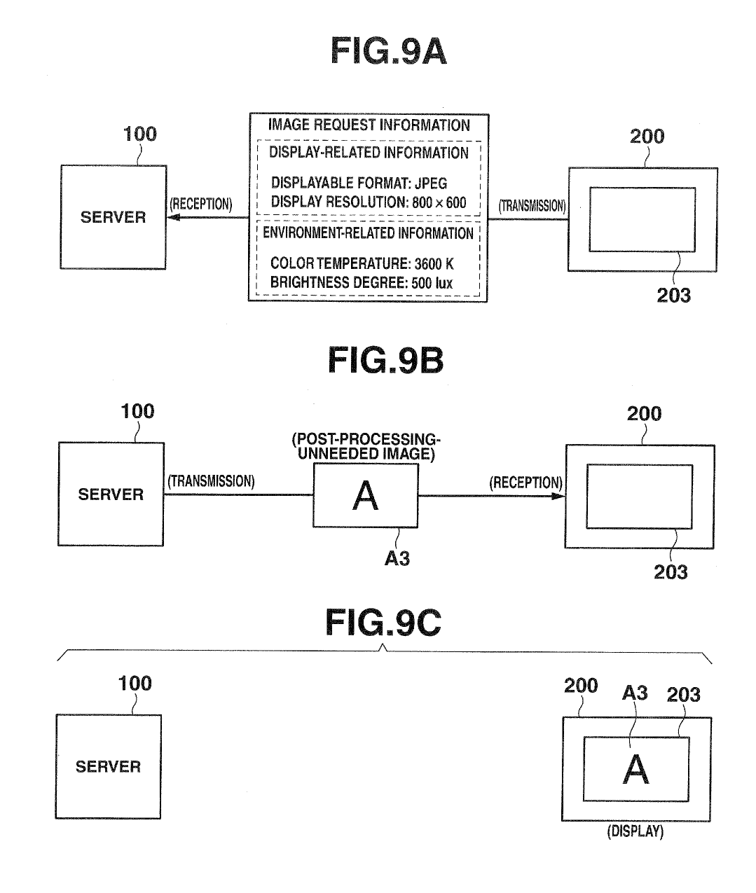

Moreover, for example, the image obtaining unit 103 may obtain such a post-processing-unneeded image corresponding to the display-related information and the environment-related information, which are stored in the storage unit 101, or alternatively, may obtain such a post-processing-unneeded image corresponding to the display-related information and the environment-related information which are transmitted from the display apparatus 200 as shown in FIG. 9A.

In the case of the example shown in FIG. 9, the display apparatus 200 first transmits an image request signal for requesting the server 100 to obtain the image to the server 100. Here, as shown in FIG. 9A, the display-related information of the display apparatus 200 and the environment-related information are included in the image request signal. As shown in FIG. 9B, the server 100 obtains the post-processing-unneeded image and transmits the post-processing-unneeded image concerned to the display apparatus 200 based on the display-related information and the environment-related information, which are included in the image request signal. Here, in the case where the post-processing-unneeded image corresponding to the display-related information and the environment-related information, which are included in the image request information, is not stored in the storage unit 101, the server 100 creates and obtains the post-processing-unneeded image by the image creating unit 102. Then, as shown in FIGS. 9B and 9C, the display apparatus 200 receives the post-processing-unneeded image, which is transmitted from the server 100 in response to the image request information, and displays the received post-processing-unneeded image.

For example, the communication control unit 104 includes a communication antenna (not shown), a communication circuit (not shown) and the like, and performs information communication control with the display apparatus 200, which is connected thereto through the communication network N, in accordance with a predetermined communication standard such as a wireless local area network (LAN).

Specifically, for example as shown in FIG. 7, the communication control unit 104 transmits the post-processing-unneeded images, which are obtained by the image obtaining unit 103, to the display apparatus 200. Here, the communication control unit 104 functions as a transmission unit that transmits the post-processing-unneeded images to the display apparatus 200.

Moreover, for example as shown in FIG. 9A, the communication control unit 104 receives the display-related information and the environment-related information, which are transmitted from the display apparatus 200.

For example, the operation input unit 105 includes input devices such as a keyboard and a mouse, and outputs predetermined operation signals to the central control unit 106 in response to input operations of the user to these input devices.

The central control unit 106 is a unit that controls the respective units of the server 100. Specifically, though not shown, the central control unit 106 includes a central processing unit (CPU), a random access memory (RAM), and a read only memory (ROM), and performs a variety of control operations in accordance with a variety of processing programs (not shown) stored in the ROM and the storage unit 101, the operation signals inputted by the operation input unit 105, and the like.

The display apparatus 200 receives the post-processing-unneeded image transmitted from the server 100, and displays the received post-processing-unneeded image. For example, the display apparatus 200 is a digital photo frame.

The display apparatus 200 includes: a communication control unit 201; a display control unit 202; a display unit 203; a recording medium control unit 204; a display-related information obtaining unit 205, an environment-related information obtaining unit 206; an operation input unit 207; and a central control unit 208.

For example, the communication control unit 201 includes a network interface card (NIC) and the like, and performs information communication control with the server 100, which is connected thereto through the communication network N, in accordance with a predetermined communication standard such as a wired LAN.

Specifically, for example as shown in FIG. 7, the communication control unit 201 receives the post-processing-unneeded image transmitted from the server 100. Here, the communication control unit 201 functions as a reception unit that receives the post-processing-unneeded images transmitted from the server 100.

Moreover, for example, as shown in FIG. 9A, the communication control unit 201 transmits the display-related information and the environment-related information, which are obtained from the display-related information obtaining unit 205 and the environment-related information obtaining unit 206, respectively, to the server 100.

The display control unit 202 performs processing related to display control to display the images on the display unit 203.

Specifically, for example, the display control unit 202 generates video signals corresponding to contents of image data of the post-processing-unneeded images (for example, the images A3, B4 and C4, which are shown in FIG. 7), which are received by the communication control unit 201, and then outputs the generated video signals to the display unit 203. Moreover, the display control unit 202 may read out image data of the post-processing-unneeded images, which is stored in a recording medium 204a, and the like, then may generate video signals corresponding to contents of the readout image data, and may output the generated video signals to the display unit 203.

For example, the display unit 203 is a liquid crystal device, and displays the images and the like on a display screen thereof in response to the video signals coming from the display control unit 202. Specifically, the display unit 203 displays the post-processing-unneeded images and the like, which are received through the communication control unit 201. Here, the display unit 203 functions as a display unit.

The recording medium control unit 204 is composed so that the recording medium 204a can be freely attached thereto and freely detached therefrom. The recording medium control unit 204 controls readout of the data from the recording medium 204a attached thereto and write of the data to the recording medium 204a.

That is to say, for example, the recording medium control unit 204 stores the image data of the post-processing-unneeded images, which are transmitted from the server 100 and received by the communication control unit 201, and the like in the recording medium 204a.

Note that, for example, the recording medium 204a is composed of a nonvolatile memory (a flash memory) or the like; however, the nonvolatile memory is merely an example, and a recording medium of the present invention is not limited to this, and can be changed appropriately and arbitrarily.

The display-related information obtaining unit 205 obtains the display-related information of the display apparatus 200.

For example, the display-related information obtaining unit 205 obtains information, which indicates formats of the images readable by the respective units such as the display control unit 202 and the central control unit 208, the respective units being related to processing for reading out the image data and displaying the images on the display unit 203, as information of the displayable formats from the respective units concerned. Moreover, for example, the display-related information obtaining unit 205 obtains a screen resolution of the display unit 203 or a resolution for use in display of the images in the screen resolution of the display unit 203 as a screen resolution from the display unit 203 and the like. The display-related information obtaining unit 205 may read out and obtain the display-related information (for example, the display formats, the display resolutions and the like) of the display apparatus 200, which is recorded in advance in a recording device (not shown; for example, a flash ROM and the like).

The environment-related information obtaining unit 206 obtains the environment-related information of the display apparatus 200.

For example, the environment-related information obtaining unit 206 includes a sensing unit 206a.

For example, the sensing unit 206a has a configuration, such as a color illuminance meter, of sensing the brightness degree and color temperature of the light. The color illuminance meter has a sensor corresponding to spectral sensitivity of human eyes, and the like. The sensor concerned is provided so as to be capable of sensing the light that illuminates the space where the display apparatus 200 exists. By the color illuminance meter, the sensing unit 206a senses the brightness degree and color temperature of the light that illuminates the space where the display apparatus 200 exits.

The environment-related information obtaining unit 206 obtains the brightness degree and color temperature of the light, which are sensed by the sensing unit 206a, as the environment-related information.

For example, the operation input unit 207 includes an operation unit composed of cursor keys, a variety of function keys and the like, which are for performing selection of the image data to be displayed on the display unit 203, feeding operations of the images, and the like. The operation input unit 207 outputs predetermined operation signals to the central control unit 208 in response to these operations of the operation unit.

The central control unit 208 is a unit that controls the respective units of the display apparatus 200. Specifically, though not shown, the central control unit 106 includes a central processing unit (CPU), a random access memory (RAM), and a read only memory (ROM), and performs a variety of control operations in accordance with a variety of processing programs (not shown) for the display apparatus 200, the operation signals inputted by the operation input unit 207, and the like.

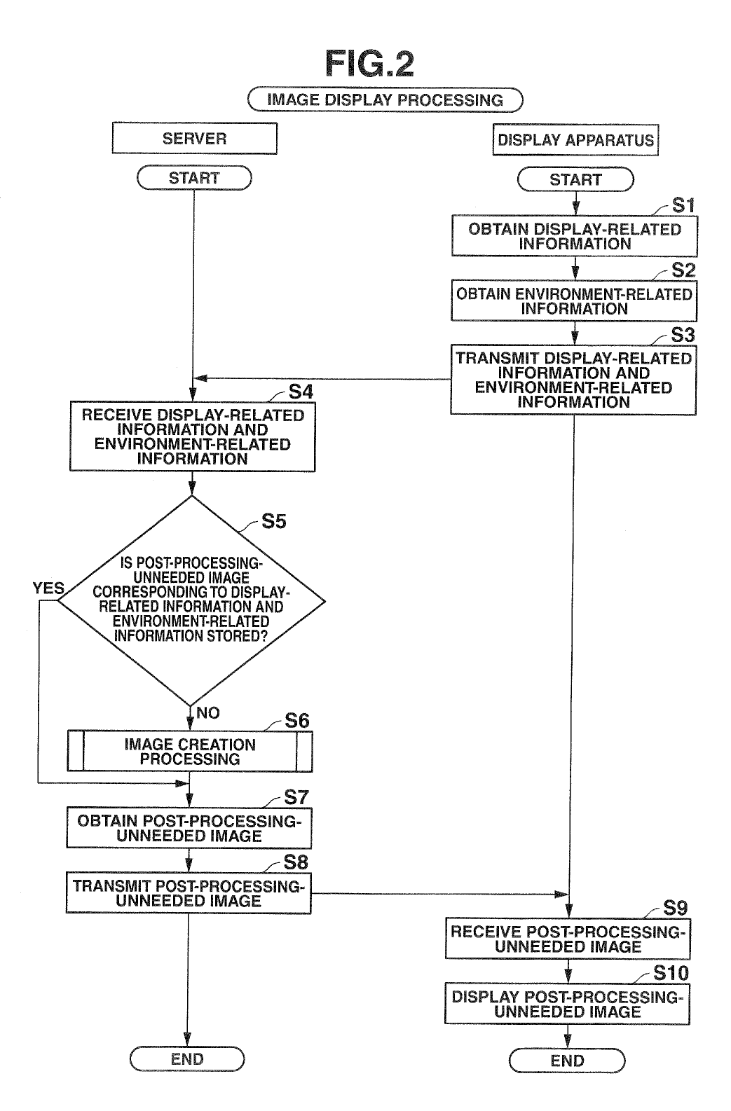

A description is made below of image display processing by the image display system 1 by using illustration by a flowchart of FIG. 2.

First, the display-related information obtaining unit 205 of the display apparatus 200 obtains the display-related information (Step S1). Specifically, for example, the display-related information obtaining unit 205 reads out and obtains the display-related information (for example, the displayable formats, the display resolutions and the like) of the display apparatus 200, which is recorded in advance in the recording device (not shown; for example, a flash ROM and the like).

Moreover, the environment-related information obtaining unit 206 of the display apparatus 200 obtains the environment-related information (Step S2). Specifically, the environment-related information obtaining unit 206 obtains the brightness degree and color temperature of the light that illuminates the space where the display apparatus 200 exists, the brightness degree and the color temperature being sensed by the sensing unit 206a, as the environment-related information.

Next, the communication control unit 201 of the display apparatus 200 transmits the display-related information and the environment-related information to the server 100 (Step S3). The communication control unit 104 of the server 100 receives the display-related information and the environment-related information, which are transmitted from the display apparatus 200 (Step S4).

Next, the image obtaining unit 103 of the server 100 determines whether or not the post-processing-unneeded image corresponding to the received display-related information and the environment-related information is stored in the storage unit 101 (Step S5). Here, in the case where it is determined that the post-processing-unneeded image corresponding to the received display-related information and the environment-related information is not stored in the storage unit 101 (Step S5: NO), then the image creating unit 102 performs the image creation processing (Step S6).

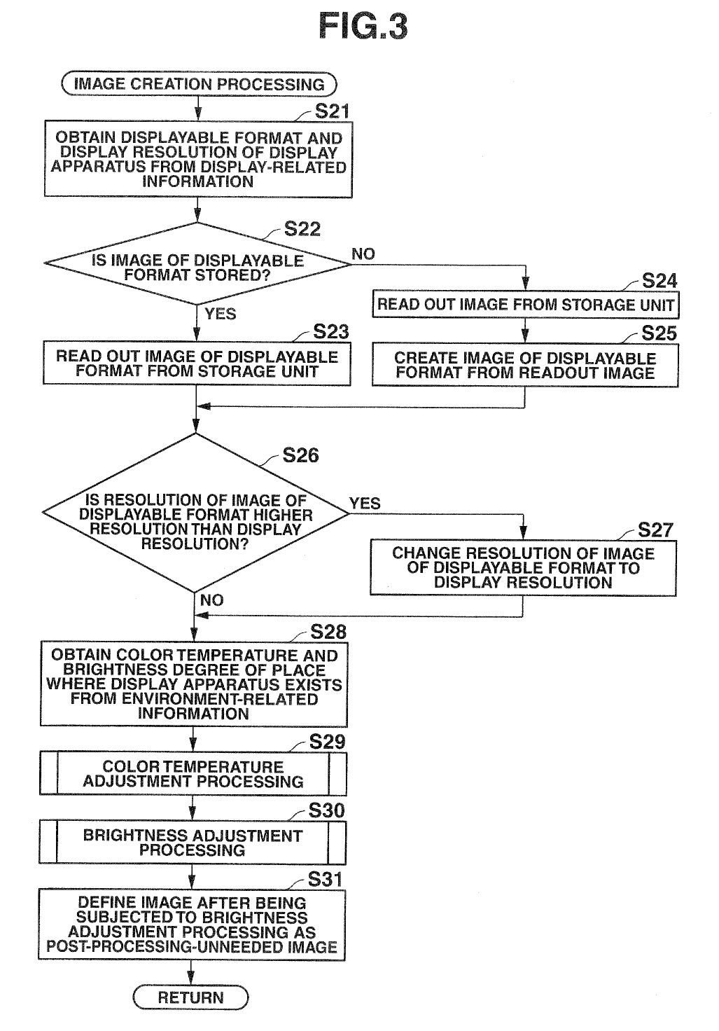

Here, a description is made of the image creation processing with reference to a flowchart of FIG. 3.

First, the image creating unit 102 obtains the displayable format and display resolution of the display apparatus 200 from the display-related information (Step S21). Next, the image creating unit 102 determines whether or not the image of the format corresponding to the displayable format obtained from the display-related information is stored in the storage unit 101 (Step S22). Here, in the case where it is determined that the image of the displayable format is stored in the storage unit 101 (Step S22: YES), the image creating unit 102 reads out and obtains the image of the displayable format from the storage unit 101 (Step S23). Meanwhile, in the case where it is determined in Step S22 that the image of the displayable format is not stored in the storage unit 101 (Step S22: NO), the image creating unit 102 reads out the image in which the format is not the displayable format, the image being stored in the storage unit 101 (Step S24), then as shown in the example of FIG. 8A, performs displayable format image creation processing for converting the format of the readout image and creating the image of the displayable format (Step S25), and obtains the created image of the displayable format.

After obtaining the image of the displayable format, the image creating unit 102 determines whether or not the resolution of the obtained image of the displayable format is a higher resolution than the display resolution obtained from the display-related information (Step S26). Here, in the case where the resolution of the image of the displayable format is a higher resolution than the display resolution (Step S26: YES), the image creating unit 102 performs display resolution changing processing for changing the resolution of the image of the displayable format and allowing the resolution concerned to correspond to the display resolution as shown in the example of FIG. 8B (Step S27).

Next, the image creating unit 102 obtains the color temperature of the light that illuminates the space where the display apparatus 200 exists and the brightness degree of the light concerned from the environment-related information (Step S28). Note that, in the case where it is determined in Step S26 that the resolution of the image of the display format is not a higher resolution than the display resolution (Step S26: NO), the image creating unit 102 shifts the processing to processing of Step S28.

Next, the image creating unit 102 performs the color temperature adjustment processing (Step S29).

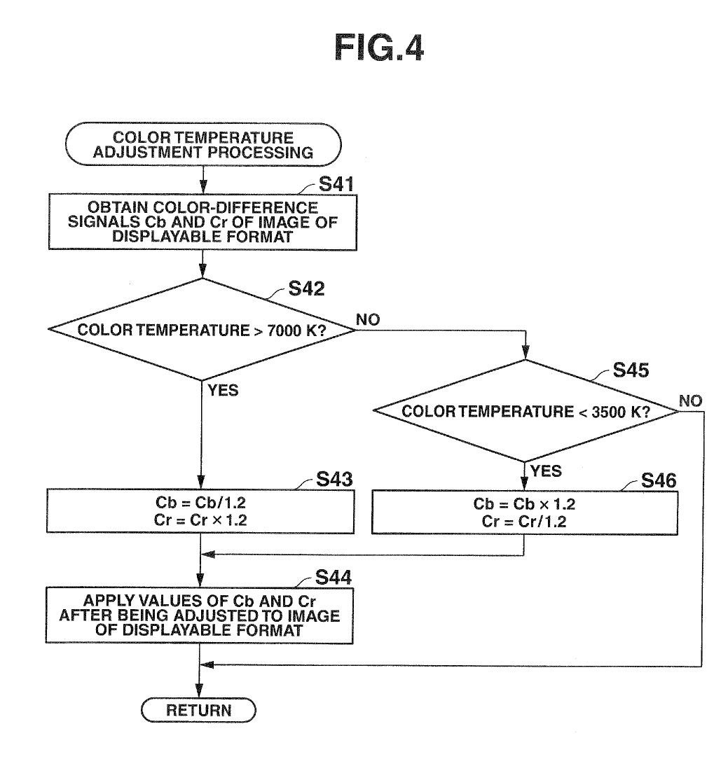

Here, a description is made of the color temperature adjustment processing with reference to a flowchart of FIG. 4.

First, the image creating unit 102 obtains the color-difference signals Cb and Cr of the image of the displayable format (Step S41). Next, the image creating unit 102 determines whether or not the value of the color temperature obtained from the environment-related information exceeds 7000 [K] (Step S42). Here, in the case where it is determined that the value of the color temperature obtained from the environment-related information exceeds 7000 [K] (Step S42: YES), the image creating unit 102 obtains the value, which is obtained by dividing the value of the color-difference signal Cb by a predetermined value (for example, 1.2), as the color-difference signal Cb after being adjusted, and obtains the value, which is obtained by multiplying the value of the color-difference signal Cr by a predetermined value, as the color-difference signal Cr after being adjusted (Step S43). Then, the image creating unit 102 applies the values of the color-difference signals Cb and Cr after being adjusted to the image of the displayable format (Step S44), and then leaves the color temperature adjustment processing.

Meanwhile, in the case where it is determined in Step S42 that the value of the color temperature obtained from the environment-related information does not exceed 7000 [K] (Step S42: NO), the image creating unit 102 determines whether or not the value of the color temperature obtained from the environment-related information falls down below 3500 [K] (Step S45). Here, in the case where it is determined that the value of the color temperature obtained from the environment-related information falls down below 3500 [K] (Step S45: YES), the image creating unit 102 obtains the value, which is obtained by multiplying the value of the color-difference signal Cb by a predetermined value (for example, 1.2), as the color-difference signal Cb after being adjusted, and obtains the value, which is obtained by dividing the value of the color-difference signal Cr by a predetermined value, as the color-difference signal Cr after being adjusted (Step S46), and then shifts the processing to processing of Step S44.

Moreover, in the case where it is determined in Step S45 that the value of the color temperature obtained from the environment-related information does not fall down below 3500 [K] (Step S45: NO), the image creating unit 102 leaves the color temperature adjustment processing.

After the color temperature adjustment processing, the image creating unit 102 performs the brightness adjustment processing (Step S30).

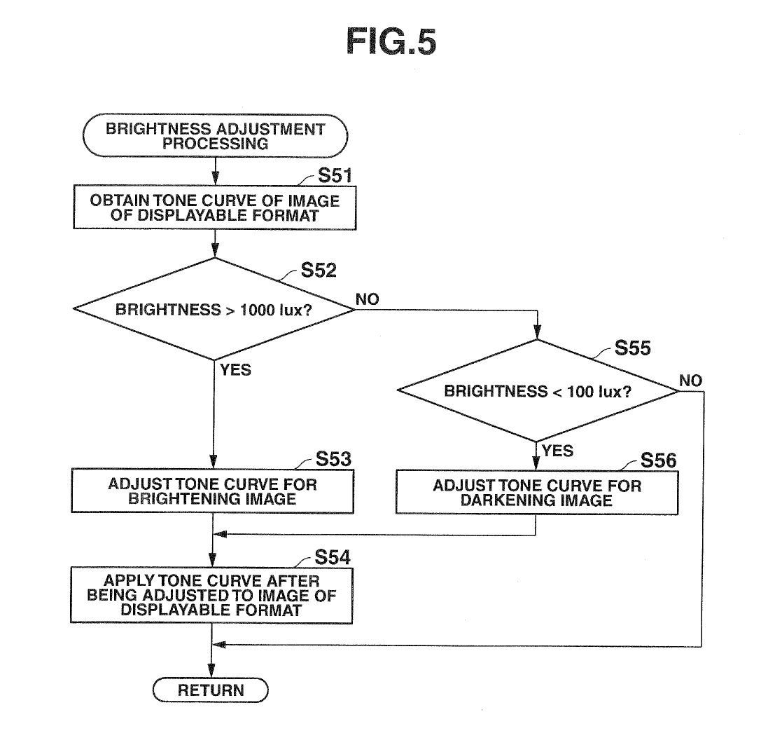

Here, a description is made of the brightness adjustment processing with reference to a flowchart of FIG. 5.

First, the image creating unit 102 obtains the tone curve of the image of the displayable format (Step S51). Next, the image creating unit 102 determines whether or not the value of the brightness degree obtained from the environment-related information exceeds 1000 [lux] (Step S52). Here, in the case where it is determined that the value of the brightness degree obtained from the environment-related information exceeds 1000 [lux] (Step S52: YES), the image creating unit 102 performs the adjustment of the tone curve for brightening the image of the displayable format (Step S53). Specifically, for example as shown in FIG. 8C, the image creating unit 102 performs the adjustment of the tone curve for obtaining the tone curve L2 in which the brightness of the image is increased in comparison with the tone curve L1 before being adjusted.

Then, the image creating unit 102 applies the tone curve after being adjusted to the image of the displayable format (Step S54), and leaves the brightness adjustment processing.

Meanwhile, in the case where it is determined in Step S52 that the value of the brightness degree obtained from the environment-related information does not exceed 1000 [lux] (Step S52: NO), the image creating unit 102 determines whether or not the value of the brightness degree obtained from the environment-related information falls down below 100 [lux] (Step S55). Here, in the case where it is determined that the value of the brightness degree obtained from the environment-related information falls down below 100 [lux] (Step S55: YES), the image creating unit 102 performs the adjustment of the tone curve for darkening the image of the displayable format (Step S56). Specifically, for example, the image creating unit 102 performs the adjustment of the tone curve for obtaining the tone curve L3 in which the brightness of the image is lowered in comparison with the tone curve L1 before being adjusted. Thereafter, the image creating unit 102 shifts the processing to Step S54.

Moreover, in the case where it is determined in Step S55 that the value of the brightness degree obtained from the environment-related information does not fall down below 100 [lux] (Step S55: NO), the image creating unit 102 leaves the brightness adjustment processing.

After the brightness adjustment processing, the image creating unit 102 defines the image of the displayable format after being subjected to the brightness adjustment processing as the post-processing-unneeded image (Step S31), and leaves the image creation processing.

After the image creation processing, the image obtaining unit 103 obtains the created post-processing-unneeded image (Step S7). Moreover, in the case where it is determined in Step S5 that the post-processing-unneeded image corresponding to the received display-related information and environment-related information is stored in the storage unit 101 (Step S5: YES), the image obtaining unit 103 reads out and obtains the post-processing-unneeded image stored in the storage unit 101 (Step S7). Next, the communication control unit 104 of the server 100 transmits the post-processing-unneeded image to the display apparatus 200 (Step S8).

The communication control unit 201 of the display apparatus 200 receives the post-processing-unneeded image transmitted from the server 100 (Step S9). Next, the display control unit 202 displays the received post-processing-unneeded image on the display unit 203 (Step S10).

As described above, in accordance with the image display system of this embodiment, based on the display-related information related to the image display performance of the display apparatus 200, the server 100 obtains the post-processing-unneeded image (for example, the image A3 shown in FIG. 7 and FIG. 9, or the like) of the format displayable without being subjected to the predetermined post-processing by the display apparatus 200, and transmits the obtained post-processing-unneeded images to the display apparatus 200. Accordingly, the display apparatus 200 can receive and display the post-processing-unneeded image transmitted from the server 100, and the display apparatus can display the image without performing the image processing.

Moreover, the display-related information includes at least one of the information indicating the screen resolution of the display unit 203 of the display apparatus 200 and the information indicating the number of pixels, which corresponds to the screen resolution concerned. Accordingly, the post-processing-unneeded image received by the display apparatus 200 becomes an image corresponding to the screen resolution of the display unit 203. That is to say, the display apparatus 200 can display the image without performing the image processing for allowing the resolution of the image displayed by the display unit 203 to correspond to the screen resolution of the display unit 203.

Moreover, the display-related information includes the information indicating the image format displayable by the display apparatus 200, and accordingly, the post-processing-unneeded image received by the display apparatus 200 becomes the image of the format displayable by the display apparatus 200. That is to say, the display apparatus 200 can display the image without performing the image processing for converting the format of the image displayed by the display unit 203 into the format displayable by the display apparatus concerned.

Moreover, the display apparatus 200 transmits the display-related information to the server 100, and the server 100 receives the display-related information transmitted from the display apparatus 200, and obtains the post-processing-unneeded image based on the received display-related information. Accordingly, even if the server 100 does not have the display-related information of the display apparatus 200 in advance, the server 100 can obtain the post-processing-unneeded image based on the display-related information transmitted from the display apparatus 200, and can transmit the post-processing-unneeded image to the display apparatus 200. In such a way, for example, in the case of adding a new display apparatus to the image display system, in the case of replacing the existing display apparatus included in the image display system by a new display apparatus different in display performance, and the like, the display of the post-processing-unneeded image by the new display apparatus can be performed without performing work for storing display-related information of the new display apparatus in the server 100 in advance.

Moreover, based on the environment-related information related to the environment of the space where the display apparatus 200 exists, the server 100 obtains the post-processing-unneeded image of the format displayable without being subjected to the predetermined post-processing by the display apparatus 200, and transmits the post-processing-unneeded image concerned to the display apparatus 200. Accordingly, the display apparatus 200 can receive and display the post-processing-unneeded image transmitted from the server 100, and the display apparatus can display the image without performing the image processing.

Moreover, the environment-related information includes at least one of the information indicating the color temperature of the light that illuminates the space where the display apparatus 200 is placed and the information indicating the degree of the brightness by the light concerned. Accordingly, the post-processing-unneeded image received by the display apparatus 200 becomes an image corresponding to the color temperature of the light that illuminates the space where the display apparatus 200 is placed, to the degree of the brightness of the light, or to both thereof. That is to say, the display apparatus 200 can display an image, which is easy to visually recognize, without performing the image processing for allowing the resolution of the image displayed by the display unit 203 to correspond to the color temperature of the light that illuminates the space where the display apparatus 200 is placed, to the degree of the brightness of the light, or to both thereof.

Moreover, the display apparatus 200 obtains the environment-related information and transmits the environment-related information concerned to the server 100, and the server 100 receives the environment-related information transmitted from the display apparatus 200, and obtains the post-processing-unneeded image based on the received environment-related information. Accordingly, the server 100 can obtain the post-processing-unneeded image based on the up-to-date environment-related information transmitted from the display apparatus 200, and can allow the display apparatus 200 to perform the display by the post-processing-unneeded image, which is matched with the up-to-date environment-related information of the space where the display apparatus 200 exists.

Moreover, for the image stored in the storage unit 101, the server 100 implements the variety of image processing by the image creating unit 102, thereby creates the post-processing-unneeded image, and obtains the created post-processing-unneeded image. Accordingly, even in the case where the server 100 does not store in advance the image corresponding to the display-related information and the environment-related information, the server 100 can transmit the post-processing-unneeded image, which is created by the image creating unit 102, to the display apparatus 200, and the display apparatus can display the image without performing the image processing.

Moreover, if an image processing apparatus, which performs such image processing for converting the image undisplayable by the display apparatus into the image displayable thereby and performs such image processing for allowing the image that does not correspond to the environment of the space where the display apparatus exists to correspond to the environment, is provided in the display apparatus, then cost of the display apparatus is further increased. Moreover, the image processing apparatus requires a processing time for performing the image processing, whereby a response of the display apparatus is lowered, for example, such that a time which the display apparatus requires for displaying the image is lengthened.

As opposed to this, it is not necessary for the image display system 1 of this embodiment to provide the image processing apparatus in the display apparatus 200. Accordingly, the image can be displayed by using the display apparatus 200 with lower cost and a better response in comparison with the display apparatus including the image processing apparatus.

Note that the present invention is not limited to the foregoing embodiment, and may be improved and changed in design in various ways within the scope without departing from the spirit of the present invention.

For example, the image to be created and obtained as the post-processing-unneeded image may be either of a still image and a moving picture.

Moreover, the server 100 may obtain at least one of the display-related information and the environment-related information, or based on either thereof, may obtain the post-processing-unneeded image.

Moreover, the display apparatus 200 is not limited to the photo frame. For example, the display apparatus 200 may be a display apparatus provided on a mobile terminal such as a wrist watch and a portable terminal. In this case, the display apparatus of the mobile terminal made compact in order to enhance portability tends to have a smaller display region in comparison with that of a tabletop display apparatus, and accordingly, a resolution thereof usable for the display of the image will also be lowered. Moreover, a memory of the mobile terminal, which is usable for the storage of the image, tends to have a smaller capacity in comparison with that of the tabletop display apparatus. Furthermore, environment-related information of a space where the mobile terminal exists is changed in response to movement of a user of the mobile terminal. For such features of the mobile terminal as described above, since the server according to the present invention obtains and transmits the post-processing-unneeded image based on the display-related information and environment-related information of the display apparatus provided in the mobile terminal, the mobile terminal can display the image on the display apparatus without performing the post-processing such as the image processing therefor, and the server can allow the mobile terminal to perform the display of the image without providing the image processing apparatus. That is to say, it becomes unnecessary to provide the image processing apparatus in the mobile terminal in which restrictions are prone to occur in design and function as the mobile terminal is being made compact, and accordingly, the mobile terminal including the display apparatus can be made as compact one with low cost.

Moreover, in the foregoing embodiment, the respective pieces of processing of the server 100 are configured to be realized in such a manner that the image obtaining unit 103, the communication control unit 104 and the like are driven under the control of the CPU of the central processing unit 106; however, the processing of the server 100 of the present invention is not limited to this, and may be configured to be realized in such a manner that predetermined programs and the like are executed by the CPU.

That is to say, in a program memory (not shown) that stores programs, a program that stores an obtainment routine and an image transmission routine is stored in advance. Then, based on the display-related information related to the image display performance of the display apparatus, by the obtainment routine, the CPU may obtain the post-processing-unneeded image of the format displayable by the display apparatus concerned without performing the predetermined post-processing. Moreover, by the image transmission routine, the CPU may transmit the obtained post-processing-unneeded image to the display apparatus.

In a similar way, other pieces of the processing by the respective units of the display apparatus 200 may also be configured to be realized in such a manner that predetermined programs and the like are executed by the CPU of the central control unit 208.

Moreover, as a computer-readable medium that stores therein the programs for executing the respective pieces of the foregoing processing, it is also possible to apply a nonvolatile memory such as a flash memory and a portable recording medium such as a CD-ROM as well as the ROM, the hard disc and the like. Moreover, as a medium that provides the data of the program through the predetermined communication network, a carrier wave is also applied.

The description has been made of some embodiments of the present invention; however, the scope of the present invention is not limited to the foregoing embodiment, and incorporates therein the scope of the invention, which is described in the scope of claims and the scope equivalent thereto.

What is claimed is:

1. An image display method using a display apparatus that displays an image, and using a server communicably connected to the display apparatus through a network, the image display method comprising:
obtaining a post-processing-unneeded image of a format displayable without performing post-processing by the display apparatus based on display-related information related to an image display performance of the display apparatus, the obtaining being performed by the server;
transmitting the post-processing-unneeded image obtained in the obtaining to the display apparatus, the transmitting being performed by the server;
receiving the post-processing-unneeded image transmitted from the server, the receiving being performed by the display apparatus; and
displaying the post-processing-unneeded image received by the receiving, the displaying being performed by the display apparatus.

2. The image display method according to claim 1, wherein the display-related information includes at least one of information indicating a screen resolution of the display apparatus, information indicating the number of pixels, the number corresponding to the screen resolution, and information indicating a format of an image, the format being displayable by the display apparatus.

3. The image display method according to claim 1, further comprising:
first transmitting the display-related information to the server, the first transmitting being performed by the display apparatus; and
first receiving the display-related information transmitted from the display apparatus, the first receiving being performed by the server,
wherein the obtaining obtains the post-processing-unneeded image based on the display-related information received in the first receiving.

4. The image display method according to claim 1, wherein the obtaining further obtains the post-processing-unneeded image of the format displayable by the display apparatus without performing predetermined image quality adjustment processing based on environment-related information related to an environment of a space where the display apparatus exists.

5. The image display method according to claim 4, wherein the environment-related information includes at least one of information indicating a color temperature of light that illuminates the space where the display apparatus exists and information indicating a degree of brightness by the light.

6. The image display method according to claim 4, further comprising:
second transmitting the environment-related information to the server, the second transmitting being performed by the display apparatus; and
second receiving the environment-related information transmitted from the display apparatus, the second receiving being performed by the server,
wherein the obtaining obtains the post-processing-unneeded image of the format displayable by the display apparatus without performing the predetermined image quality adjustment processing based on the environment-related information received in the second receiving.

7. The image display method according to claim 1, further comprising:
creating the post-processing-unneeded image by implementing predetermined processing for an image stored in a predetermined storage unit,
wherein the obtaining obtains the post-processing-unneeded image created in the creating.

8. A server communicably connected to a display apparatus that displays an image through a network, the server comprising:
an obtaining unit which obtains a post-processing-unneeded image of a format displayable without performing post-processing by the display apparatus based on display-related information related to an image display performance of the display apparatus; and
an image transmission unit which transmits the post-processing-unneeded image obtained by the obtaining unit to the display apparatus.

9. An image display system comprising a display apparatus that displays an image, and a server communicably connected to the display apparatus through a network,
wherein the server comprises:
an obtaining unit which obtains a post-processing-unneeded image of a format displayable without performing post-processing by the display apparatus based on display-related information related to an image display performance of the display apparatus; and
an image transmission unit which transmits the post-processing-unneeded image obtained by the obtaining unit to the display apparatus;
and wherein the display apparatus comprises:
an image reception unit which receives the post-processing-unneeded image transmitted from the server; and
a display unit which displays the post-processing-unneeded image received by the image reception unit.
